(19) United States
(12) Patent Application Publication
(10) Pub. No.: US 2015/0269526 A1
(43) Pub. Date: Sep. 24, 2015

(54) METHOD AND SYSTEM FOR MATCHING A JOBSEEKER AND A JOB PROVIDER

(71) Applicant: Kenneth E. Brown, Litchfield Park, AZ (US)

(72) Inventor: Kenneth E. Brown, Litchfield Park, AZ (US)

(73) Assignee: NXMOOV LLC, Litchfield Park, AZ (US)

(21) Appl. No.: 14/218,046

(22) Filed: Mar. 18, 2014

(51) Int. Cl. G06Q 10/10

(52) U.S. Cl. CPC G06Q 10/1053

(57) ABSTRACT

A method and system for matching a jobseeker and a job provider. Particularly, the application provides a web based method and system for deriving at least one unique match between at least one qualification attributes of a jobseeker and attributes of job specification defined by a hiring manager. More particularly, the present application provides a method and system which is characterized in deriving said unique match out of a plurality of selectively invited jobseekers for applying by hiring manager.

### FIELD OF THE INVENTION

The present application generally relates to the field of web based employment. Particularly, the application provides a method and system for deriving at least one unique match between a jobseeker and a job provider wherein the job provider is a hiring manager.

### BACKGROUND

The traditional web based job application portals enables jobseekers and job providers to exchange information for the purposes of filling open position requirements. During a typical hiring process a hiring manager receives a plurality of resume/cv profiles from corporate or agency recruiters, which may have assessed an even larger number of jobseekers resumes/cv profiles against a posted job opening. Among all the application, there may be many unwarranted application, unnecessary corporate or agency recruiter assessments and jobseeker evaluations, which may be unsolicited by hiring manager. In most of the cases, the resumes/cv profiles submitted by corporate and agency recruiters are not sufficient for the hiring manager which results in a repetitive back and forward time consuming evaluations until a pool of qualified jobseekers resume/cv profiles are selected for the interview process. Such exercise requires substantial time and efforts; slows down the hiring process as well as dramatically affect hiring outcomes. The downstream steps of the hiring process such as detail analysis of resume/cv profiles, interview and hiring follows after hiring manager have a relevant set of profiles.

Prior art literature doesn't illustrate of solutions wherein jobseekers with relevant profile could be identified at the beginning of the hiring process. Prior art doesn't provide any solution wherein scrutiny of unsolicited and irrelevant jobseeker's profile could be avoided at first instance to streamline hiring process.

Thus, in the light of the above mentioned background discussion, it is evident that, there is a need for a solution which could bring jobseekers with relevant profiles and hiring managers together at the beginning of the hiring process. There is also a need for a solution which could eliminate unsolicited, unwarranted and unnecessary corporate; agency recruiter assessments and jobseeker evaluations that slow and dramatically affect hiring outcomes. A method and system is desired for matching specific jobseeker characteristics and attributes with hiring manager job specifications.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a web based method and system for deriving at least one unique match between at least one qualification attributes of a jobseeker and attributes of job specification defined by a hiring manager; characterized in deriving said unique match out of a plurality of selectively invited jobseekers for applying by hiring manager.

Another objective is to provide a method and system for posting job specification for required position; authenticating and approving said posted job specification; defining a minimum threshold level as a primary selection criteria for matching at least one qualification attribute of the jobseeker to the attributes of job specifications; presenting the hiring manager with results of identified matched of jobseekers with matching percentages according to the defined minimum threshold level; inviting at least one selected jobseeker out of the identified match of jobseekers according for applying against posted job specification for required position on a jobseeker's component (204) of the web portal (200); receiving invites by at least one jobseeker sent for applying against posted job specification for required position; applying for said position by at least one jobseeker; receiving selectively invited at least one jobseeker's application and deriving said unique match between qualification attributes of the at least one selectively invited jobseeker out of the plurality of selectively invited jobseekers and the attributes of the job specification defined by the hiring manager.

The above said method and system is provided for method and system for deriving at least one unique match between at least one qualification attributes of a jobseeker and attributes of job specification defined by a hiring manager but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1: shows a flow chart illustrating method for deriving at least one unique match between at least one qualification attributes of a jobseeker and attributes of job specification defined by a hiring manager.

FIG. 2: shows a block diagram illustrating architecture of deriving at least one unique match between at least one qualification attributes of a jobseeker and attributes of job specification defined by a hiring manager.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

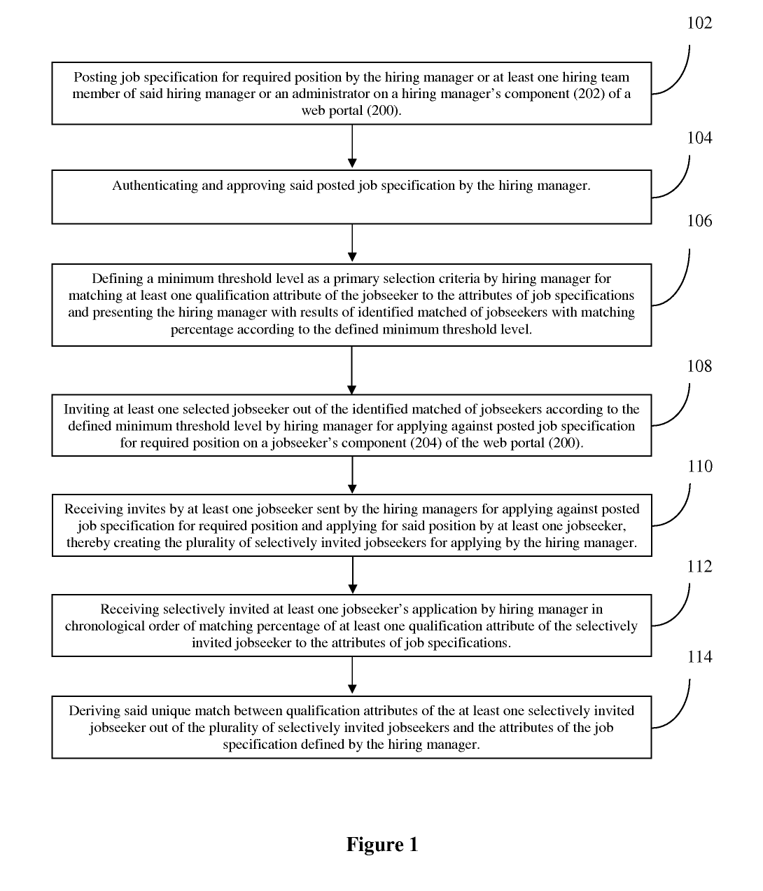

Referring to FIG. 1 is a flow chart illustrating method for deriving at least one unique match between at least one qualification attributes of a jobseeker and attributes of job specification defined by a hiring manager.

The process starts at the step 102, a job specification for required position is posted by the hiring manager or at least one hiring team member of said hiring manager or an administrator on a hiring manager's component (202) of a web portal (200). At the step 104, the posted job specification is authenticated and approved by the hiring manager. At the step 106, a minimum threshold level is defined as a primary selection criteria by hiring manager for matching at least one qualification attribute of the jobseeker to the attributes of job specifications and presenting the hiring manager with results of identified matched of jobseekers with matching percentage according to the defined minimum threshold level. At the step 108, at least one selected jobseeker out of the identified matched of jobseekers according to the defined minimum threshold level is invited by the hiring manager for applying against posted job specification for required position on a jobseeker's component (204) of the web portal (200). At the step 110, invites are received by at least one jobseeker sent by the hiring managers for applying against posted job specification for required position and applying for said position by at least one jobseeker, thereby creating the plurality of selectively invited jobseekers for applying by the hiring manager. At the step 112, selectively invited at least one jobseeker's application is received by hiring manager in chronological order of matching percentage of at least one qualification attribute of the selectively invited jobseeker to the attributes of job specifications. The process ends at the step 114, the unique match between qualification attributes of the at least one selectively invited jobseeker out of the plurality of selectively invited jobseekers and the attributes of the job specification defined by the hiring manager is derived.

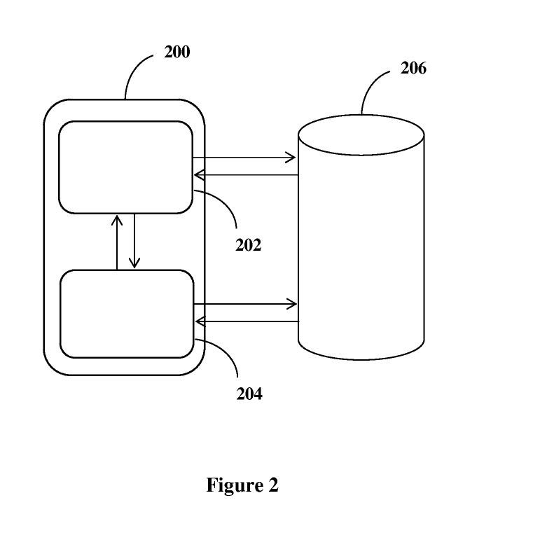

Referring to FIG. 2 is block diagram illustrating architecture for deriving at least one unique match between at least one qualification attributes of a jobseeker and attributes of job specification defined by a hiring manager.

In an embodiment of the present invention, a system for deriving at least one unique match between at least one qualification attributes of a jobseeker and attributes of job specification defined by a hiring manager; the system comprises of a web portal (200) and an electronic data storage device (206) acting as a storage medium.

In another embodiment of the present invention, the web portal (200) further comprising of a hiring manager's component (202) of the web portal (200).

In another embodiment of the present invention, a job specification is posted for required position by the hiring manager or at least one hiring team member of said hiring manager or an administrator on a hiring manager's component (202) of a web portal (200). The hiring manager may be a registered or subscribed user on the web portal (200) and may be given hiring authority privileges for seeking jobseekers. The hiring team may be having a plurality of members, wherein each member may be a registered or subscribed user on the web portal (200) and may be assisting hiring manager in hiring process. The administrator may be a registered or subscribed user on the web portal (200) and may be given specific rights for managing company user permissions and system configurations.

In another embodiment of the present invention, the hiring manager may register and create profile using the hiring manager's component (202) of the web portal (200) by manually entering information required by the web portal (200).

In an alternative embodiment of the present invention, the hiring manager may register and create profile using the hiring manager's component (202) of the web portal (200) by fetching their existing profiles on social networking portals selected from a group comprising of LinkedIn, Facebook, and Google Plus.

In another embodiment of the present invention, the hiring manager's component (202) of a web portal (200) enables the hiring manager to edit created profiles, creating job posts with job specification, editing job posts, defining a minimum threshold level as a primary selection criteria, viewing numerical matching results, sending invites, viewing invited respondents, viewing applicant respondents, disqualifying applicants, chatting live with jobseekers who are viewing job postings, requesting more information pertaining to jobseeker, viewing daily user activity, receiving email and sms updates, sending calendar invites such as phone screening or interview, moving and managing applicants through the workflow, recording notes on job applicants, sending offers, hiring and closing jobs and changing user settings.

In another embodiment of the present invention, said posted job specification is authenticated and approved by the hiring manager.

In another embodiment of the present invention, a minimum threshold level is defined as a primary selection criteria by hiring manager for matching at least one qualification attribute of the jobseeker to the attributes of job specifications and presenting the hiring manager with results of identified matched of jobseekers with matching percentage according to the defined minimum threshold level. The at least one attribute of jobseekers qualification is selected from a group comprising of job category, job function, job function experience, location, career level, current employment type, work authorization, education, industry, salary and skills. The minimum threshold level of the primary selection criteria defined by hiring manager is selected from 70%+, 80%+, and 90%+ matching of at least one qualification attribute of the jobseeker to job specifications using a sliding percentage scale. The minimum threshold level of the primary selection criteria defined by hiring manager may be modified by −10% matching of at least one qualification attribute of the jobseeker to job specifications, wherein jobseekers may be considered fitting in the modified criteria.

The jobseeker is a registered user on the of the web portal (200) who is seeking a new job. The jobseeker may register and create profile using the jobseeker's component (204) of the web portal (200) by manually entering information required by the web portal (200).

In an alternative embodiment of the present invention, the jobseeker may register and create profile using the jobseeker's component (204) of the web portal (200) by fetching their existing profiles on social networking portals selected from a group comprising of LinkedIn, Facebook, and Google Plus.

The jobseeker's component (204) of the web portal (200) enables the jobseeker to edit created profile, changing job search criteria, receiving job application invites, disqualifications, receiving job alerts, viewing job posting, live chatting with hiring managers, requesting hiring managers for more details pertaining to job posting, receiving job status, see daily user activity, receiving email and sms for updates, request profile endorsements, accepting or declining event such as phone screening or interview invites, receiving job offers, and following hiring manager profiles, change user settings, and manage subscriptions.

In another embodiment of the present invention, at least one selected jobseeker out of the identified matched of jobseekers according to the defined minimum threshold level is invited by hiring manager for applying against posted job specification for required position on a jobseeker's component (204) of the web portal (200).

In another embodiment of the present invention, selectively invited at least one jobseeker's application is received by hiring manager in chronological order of matching percentage of at least one qualification attribute of the selectively invited jobseeker to the attributes of job specifications.

In another embodiment of the present invention, said unique match between qualification attributes of the at least one selectively invited jobseeker out of the plurality of selectively invited jobseekers and the attributes of the job specification defined by the hiring manager is derived.

In another embodiment of the present invention, the web portal (200) further comprising of a jobseeker's component (204) of the web portal (200); which enables the jobseeker for receiving invites by at least one jobseeker sent by the hiring managers for applying against posted job specification for required position and applying for said position by at least one jobseeker, thereby creating the plurality of selectively invited jobseekers for applying by the hiring manager.

In another embodiment of the present invention, said electronic data storage device acting as the storage medium (206) is communicatively coupled with the hiring manager's component of the web portal (202) and jobseeker's component (204) of the web portal (200) and adapted to store the qualification attributes of the jobseeker and the attributes of job specifications posted by the hiring manager.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

We claim:

1. A web based method for deriving at least one unique match between at least one qualification attributes of a jobseeker and attributes of job specification defined by a hiring manager; characterized in deriving said unique match out of a plurality of selectively invited jobseekers for applying by hiring manager; the method comprises processor implemented steps of:
a. posting job specification for required position by the hiring manager or at least one hiring team member of said hiring manager or an administrator on a hiring manager's component (202) of a web portal (200);
b. authenticating and approving said posted job specification by the hiring manager;
c. defining a minimum threshold level as a primary selection criteria by hiring manager for matching at least one qualification attribute of the jobseeker to the attributes of job specifications and presenting the hiring manager with results of identified matched of jobseekers with matching percentage according to the defined minimum threshold level;
d. inviting at least one selected jobseeker out of the identified matched of jobseekers according to the defined minimum threshold level by hiring manager for applying against posted job specification for required position on a jobseeker's component (204) of the web portal (200);
e. receiving invites by at least one jobseeker sent by the hiring managers for applying against posted job specification for required position and applying for said position by at least one jobseeker, thereby creating the plurality of selectively invited jobseekers for applying by the hiring manager;
f. receiving selectively invited at least one jobseeker's application by hiring manager in chronological order of matching percentage of at least one qualification attribute of the selectively invited jobseeker to the attributes of job specifications; and
g. deriving said unique match between qualification attributes of the at least one selectively invited jobseeker out of the plurality of selectively invited jobseekers and the attributes of the job specification defined by the hiring manager.

2. The method of claim 1, wherein the jobseeker, hiring manager, hiring team members of hiring manager, and the administrator are registered and subscribed users of said web based portal (200).

3. The method of claim 1, further enabling the jobseeker and hiring manager to register and create profile using the jobseeker's component (204) of the web portal (200) and the hiring manager's component (202) of a web portal (200) respectively by manually or fetching their existing profiles on social networking portals selected from a group comprising of LinkedIn, Facebook, and Google Plus.

4. The method of claim 1, further enabling the jobseeker to edit created profile, changing job search criteria, receiving job application invites, disqualifications, receiving job alerts, viewing job posting, live chatting with hiring managers, requesting hiring managers for more details pertaining to job posting, receiving job status, see daily user activity, receiving email and sms for updates, request profile endorsements, accepting or declining event such as phone screening or interview invites, receiving job offers, and following hiring manager profiles, change user settings, and manage subscriptions using the jobseeker's component (204) of the web portal (200)

5. The method of claim 1, further enabling the hiring manager to edit created profiles, creating job posts with job specification, editing job posts, defining a minimum threshold level as a primary selection criteria, viewing numerical matching results, sending invites, viewing invited respondents, viewing applicant respondents, disqualifying applicants, chatting live with jobseekers who are viewing job postings, requesting more information pertaining to jobseeker, viewing daily user activity, receiving email and sms updates, sending calendar invites such as phone screening or interview, moving and managing applicants through the workflow, recording notes on job applicants, sending offers, hiring and closing jobs and changing user settings using hiring manager's component (202) of a web portal (200)

6. The method of claim 1, further comprises on storing the qualification attributes of the jobseeker and the attributes of job specifications posted by the hiring manager on an electronic data storage device acting as a storage medium (206).

7. The method of claim 1, wherein said minimum threshold level of the primary selection criteria defined by hiring manager is selected form 70%+, 80%+, and 90%+ matching of at least one qualification attribute of the jobseeker to job specifications using a sliding percentage scale.

8. The method of claim 1, wherein said at least one attribute of jobseekers qualification is selected from a group comprising of job category, job function, job function experience, location, career level, current employment type, work authorization, education, industry, salary and skills.

9. A system for deriving at least one unique match between at least one qualification attributes of a jobseeker and attributes of job specification defined by a hiring manager; the system comprises of a web portal (200) and an electronic data storage device (206) acting as a storage medium, wherein the web portal (200) further comprising of:
a. a hiring manager's component (202) of the web portal (200); enabling the hiring manager or at least one hiring team member of said hiring manager or an administrator for posting job specification for required position; authenticating and approving said posted job specification by the hiring manager; defining a minimum threshold level as a primary selection criteria for matching at least one qualification attribute of the jobseeker to the attributes of job specifications and presenting the results of identified matched of jobseekers with matching percentage; inviting at least one selected jobseeker out of the identified matched of jobseekers for applying against posted job specification for required position; and receiving selectively invited at least one jobseeker's application by in chronological order of matching percentage of at least one qualification attribute of the selectively invited jobseeker to the attributes of job specifications; and
b. a jobseeker's component (204) of the web portal (200); enabling the jobseeker for receiving invites sent by the hiring managers for applying against posted job specification for required position and applying for said position.

10. The system of claim 9, wherein said electronic data storage device acting as the storage medium (206) is communicatively coupled with the hiring manager's component of the web portal (202) and jobseeker's component (204) of the web portal (200) and adapted to store the qualification attributes of the jobseeker and the attributes of job specifications posted by the hiring manager.

11. A computer program adapted for deriving at least one unique match between qualification attributes of the jobseeker and attributes of job specification defined by the hiring manager; the computer program comprising:
a. a program code adapted for posting job specification for required position by the hiring manager or at least one hiring team member of said hiring manager or an administrator on a hiring manager's component (202) of a web portal (200);
b. a program code adapted for authenticating and approving said posted job specification by the hiring manager;
c. a program code adapted for defining a minimum threshold level as a primary selection criteria by hiring manager for matching at least one qualification attribute of the jobseeker to the attributes of job specifications and presenting the hiring manager with results of identified matched of jobseekers with matching percentage according to the defined minimum threshold level;
d. a program code adapted for inviting at least one selected jobseeker out of the identified matched of jobseekers according to the defined minimum threshold level by hiring manager for applying against posted job specification for required position on a jobseeker's component (204) of the web portal (200);
e. a program code adapted for receiving invites by at least one jobseeker sent by the hiring managers for applying against posted job specification for required position and applying for said position by at least one jobseeker, thereby creating the plurality of selectively invited jobseekers for applying by the hiring manager;
f. a program code adapted for receiving selectively invited at least one jobseeker's application by hiring manager in chronological order of matching percentage of at least one qualification attribute of the selectively invited jobseeker to the attributes of job specifications; and
g. a program code adapted for deriving said unique match between qualification attributes of the at least one selectively invited jobseeker out of the plurality of selectively invited jobseekers and the attributes of the job specification defined by the hiring manager.
